(19) United States
(12) Patent Application Publication
(10) Pub. No.: US 2014/0067275 A1
(43) Pub. Date: Mar. 6, 2014

(54) MULTIDIMENSIONAL CLUSTER ANALYSIS

(71) Applicants: Junmei Jing, Palmerston (AU); Inge Koch, Belair (AU); John James Zaunders, Kingsford (AU)

(72) Inventors: Junmei Jing, Palmerston (AU); Inge Koch, Belair (AU); John James Zaunders, Kingsford (AU)

(21) Appl. No.: 14/004,161

(22) PCT Filed: Mar. 9, 2012
(86) PCT No.: PCT/AU12/00252

§ 371 Date: Nov. 18, 2013

(30) Foreign Application Priority Data
Mar. 10, 2011 (AU) 2011900867

(51) Int. Cl. G06F 19/24

(52) U.S. Cl. CPC G06F 19/24
USPC 702/19

(57) ABSTRACT

Disclosed is a method of cluster analysis of a data set of multidimensional observations. The method comprises: determining a set of quasi-optimal binwidths for the data set; partitioning, for a current binwidth in the set of quasi-optimal binwidths, the data set into a plurality of bins of width equal to the current binwidth; determining the number of modes of the partitioned data set for the current binwidth; and repeating the partitioning and determining the number of modes for each binwidth in the set of quasi-optimal binwidths. The number of clusters in the data set is the largest determined number of modes over the set of quasi-optimal binwidths.

### RELATED APPLICATION PRIORITY

The present application is entitled to the benefit of the filing date of Australian provisional application no. 2011900867, the specification of which is incorporated herein in its entirety by reference.

### TECHNICAL FIELD

The present invention relates generally to statistical analysis and, in particular, to cluster analysis of multidimensional observations of living cells.

### BACKGROUND

Lymphocytes were originally studied by light microscopy, appearing mostly as relatively homogeneous small round cells with minimal cytoplasm. The advent of monoclonal antibodies and flow cytometry revealed a remarkable heterogeneity of differentiated lymphocyte cell types with diverse immunological properties, particularly among T lymphocytes. Clustering of multiple cell surface and/or intracellular lineage markers on a large number of individual T lymphocytes provides populations or “clusters” of cells each with similar combinations of markers, which are interpreted as functional subsets of T lymphocytes. Using various lasers and fluorochromes it is now possible to analyse 20 or more markers simultaneously on individual cells, and use of mass spectrometry instead of fluorochromes may increase this to 100 or more markers. As the number of markers increases, an increasing total number of cells must be analysed to reliably estimate smaller and smaller subpopulations of cells. As the number of different monoclonal antibodies that can be detected on individual cells increases, the complexity of clustering data of 20-30 dimensions for tens to hundreds of thousands of cells, also increases. Therefore, clustering of multidimensional (or multivariate) flow cytometry data represents a new challenge that involves efficiently estimating the number of clusters and their centres over potentially millions of data points in a moderate number of dimensions.

Currently, subsets of lymphocytes are analysed by visual inspection of combinations of one-dimensional histograms and two-dimensional scatter plots and point clouds. Multidimensional data from flow cytometry can be visualized as all possible pairwise combinations of variables, with clusters identified by inspection through their much higher frequency than other combinations. Three-dimensional analysis is limited by the difficulty in visualising and gating (separating) subpopulations in three dimensions. Kernel density estimation methods work well as clustering tools for two- and three-dimensional data, and are able to estimate the number of clusters. However, such methods become computationally intensive in multiple dimensions. A clustering method based on two-dimensional bins has been shown to be useful for comparing two sets of multivariate data, but does not necessarily recognize discrete subpopulations. Other clustering methods based on Gaussian mixture model (GMM) density estimation have been described, but are computationally intensive and, unlike kernel methods, require the user to specify the number of modes (clusters). In addition, flow cytometry data is usually non-Gaussian, which affects the suitability of GMM density estimation to such data sets. In another clustering method, using finite mixture modelling, allowance was made for skewing of subpopulations. However, such methods also require predetermination of the number of modes, and therefore are less useful to analyse data comprising observations in four or more dimensions.

Therefore, a need exists for a clustering method that efficiently identifies potentially important subpopulations in multidimensional data sets, with particular emphasis on high throughput cluster analysis and/or discovery.

### SUMMARY

It is an object of the present invention to substantially overcome, or at least ameliorate, one or more disadvantages of existing arrangements.

Disclosed are methods for cluster analysis of multidimensional data, based on polynomial histogram estimation. The disclosed methods are suitable for abundant data sets in a moderate number of dimensions, such as obtained from multidimensional flow cytometry. The disclosed methods require much smaller numbers of bins in each dimension than conventional multidimensional density estimation methods, with the result that computation is comparatively rapid. In addition, the number of clusters does not need to be specified as an input to the disclosed methods.

According to a first aspect of the present invention, there is provided a method of cluster analysis of a data set of multidimensional observations, the method comprising: determining a set of quasi-optimal binwidths for the data set; partitioning, for a current binwidth in the set of quasi-optimal binwidths, the data set into a plurality of bins of width equal to the current binwidth; determining the number of modes of the partitioned data set for the current binwidth; and repeating the partitioning and determining the number of modes for each binwidth in the set of quasi-optimal binwidths, wherein the number of clusters in the data set is the largest determined number of modes over the set of quasi-optimal binwidths.

According to a second aspect of the present invention, there is provided a computer readable medium on which is recorded computer program code executable by a computer apparatus to cause the computer apparatus to perform a method of cluster analysis of a data set of multidimensional observations, said code comprising code for determining a set of quasi-optimal binwidths for the data set; code for partitioning, for a current binwidth in the set of quasi-optimal binwidths, the data set into a plurality of bins of width equal to the current binwidth; code for determining the number of modes of the partitioned data set for the current binwidth; and code for repeating the partitioning and determining the number of modes for each binwidth in the set of quasi-optimal binwidths, wherein the number of clusters in the data set is the largest determined number of modes over the set of quasi-optimal binwidths.

According to a third aspect of the present invention, there is provided computer program code executable by a computer apparatus to cause the computer apparatus to perform a method of cluster analysis of a data set of multidimensional observations, said code comprising: code for determining a set of quasi-optimal binwidths for the data set; code for partitioning, for a current binwidth in the set of quasi-optimal binwidths, the data set into a plurality of bins of width equal to the current binwidth; code for determining the number of modes of the partitioned data set for the current binwidth; and code for repeating the partitioning and determining the number of modes for each binwidth in the set of quasi-optimal binwidths, wherein the number of clusters in the data set is the largest determined number of modes over the set of quasi-optimal binwidths.

Other aspects of the invention are also disclosed.

### DESCRIPTION OF THE DRAWINGS

At least one embodiment of the present invention will now be described with reference to the drawings, in which:

FIG. 1 is a flow chart illustrating a method of cluster analysis of a multidimensional data set, according to one embodiment;

FIG. 2 is a flow chart illustrating a method of determining a set of “quasi-optimal” binwidths for a multidimensional data set;

FIG. 3 contains a plot of the performance curves of the disclosed method and a histogram estimator for a sample two-variable data set;

FIGS. 4A and 4B collectively form a schematic block diagram of a general purpose computer system on which the methods of FIGS. 1 and 2 may be implemented;

FIG. 5 is a flow chart illustrating a method of determining the number and locations of modes of a multidimensional data set, as used in the method of FIG. 1; and

FIG. 6 is a flow chart illustrating a method of cluster analysis of a multidimensional data set, according to one embodiment.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

For univariate and bivariate data, typically the whole probability density function (or simply density) is estimated for clustering purposes, but as the number of dimensions increases, the data often become more concentrated in a number of clusters, and large regions of the variable space are empty. For this reason, the focus shifts: instead of estimating the whole density, for multidimensional data, the disclosed methods concentrate on clusters. Of particular interest are:
1. The number of clusters (or modes) and their locations.
2. The extent of the modal region which corresponds to each mode.
3. The proportion of the data that belongs to each modal region.

The disclosed methods of cluster analysis are suitable for data that needs to be partitioned into two or more ‘subpopulations’ with similar properties in order to determine the structure of the data. Analysing individual cell populations in flow cytometry is one such application. Other potential applications are:
Gene expression data sets (microarray data) in biotechnology that have been observed at different times. In this case, the time points are the variables and the individual genes are the observations, and clustering groups the genes into clusters that behave similarly over time.
Financial data: different securities that have been observed over a number of time points. Again the time points are the variables, and clustering groups the securities into clusters that behave similarly over time.

The disclosed methods can be applied to two or more data sets that need to be compared. In the medical area, and in particular in flow cytometry, it is believed that the structure of the cell populations change with the onset of a disease. In most data sets with 10 to 20 variables, it is not clear how to find these changes in the raw data, but cluster analysis of each of the data sets leads to a small number of descriptors for each data set (the number, the location, and the extent of the clusters). These descriptors can be compared across different data sets in several applications:
A sequence of data sets obtained from a patient at different time points can be used in diagnosing abnormalities or the onset of a disease, or to monitor the progress of a disease, or the improvement of a disease with medication.
A pair of data sets, one from a healthy subject and one from a patient, may be used to aid in diagnosing diseases.
A plurality of data sets for one subject at a fixed time point leads to an understanding of the natural variability of the cluster structure.

Notation. Vectors are denoted herein by bold characters, such as a, x and X. Matrices are denoted by unbolded italicised capitals such as A and S. The identity matrix is denoted by I and the identity and zero vectors by 1 and 0 respectively. Further, for a matrix A, diag(A) denotes the diagonal matrix of A, and tr(A) denotes its trace (a scalar).

Let Xᵢ denote the n random vectors (observations) in d dimensions with real entries, with i=1, . . . n. It is assumed throughout that the observations have been centred, i.e. the sample mean has been subtracted from each observation vector X. The observation vectors are partitioned into L equally sized bins, denoted by Bₗ, (l=0, . . . , L−1). Each bin is a d-dimensional cube of size h^{d}, where h>0 is the binwidth. The centre of bin Bₗ is denoted by tₗ. The 0-th bin B₀ is centred at the origin, so t₀=0.

The number of observations Xᵢ in bin Bₗ is denoted by nₗ, while Iₗ denotes the indicator function for bin Bₗ. The mean x̅ₗ of the observations Xᵢ in bin Bₗ is computed as

$${\overline{x}}_{l} = \frac{1}{{n}_{l}} {\sum }_{i = 1}^{n} {ℐ}_{l} ( {X}_{i} ) {X}_{i} \qquad ( 1 )$$

Further, Sₗ denotes a d-by-d “modified covariance” matrix of the observations Xᵢ in bin Bₗ, computed with reference to the bin centre tₗ rather than the bin mean x̅ₗ as follows:

$${S}_{l} = \frac{1}{{n}_{l}} {\sum }_{i = 1}^{n} {ℐ}_{l} ( {X}_{i} ) ( {X}_{i} - {t}_{l} ) {( {X}_{i} - {t}_{l} )}^{T} \qquad ( 2 )$$

Mₗ denotes a d-by-d matrix of second moments of the observations Xᵢ in binBₗ:

$${M}_{l} = \frac{1}{{n}_{l}} {\sum }_{i - 1}^{n} {ℐ}_{l} ( {X}_{i} ) {X}_{i} {X}_{i}^{T} \qquad ( 3 )$$

The “true” multivariate density of the observations Xᵢ is denoted by ƒ, where ƒ is a function from [symbol] ^{d} to [symbol] ⁺. The disclosed cluster analysis methods begin by determining estimates g of ƒ.

The disclosed methods operate independently on each bin Bₗ, for l=0, . . . , L−1. The first-order polynomial histogram estimator (“FOPHE”) forms an estimate g₁ of ƒ as a first-order (linear) polynomial in the real d-vector x in each bin Bₗ:

g₁(x)+a₀+a^{T}x (4)

where the superscript T indicates the transpose.

The second-order polynomial histogram estimator (“SOPHE”) forms an estimate g2 of ƒ as a second-order (quadratic) polynomial in x in each bin Bₗ:

g₂(x)=a₀+a^{T}x+x^{T}Ax (5)

The FOPHE involves estimation of the coefficients aₒ and a in each bin Bₗ, while the SOPHE involves estimation of the coefficients a₀, a, and A in each bin Bₗ. (A conventional histogram is “flat-topped”, i.e. is a zero-order polynomial with only one coefficient, a₀, in each bin.) (The coefficients a₀ and a differ between FOPHE and SOPHE, so where a distinction is required it will be indicated herein by a superscripted [1] or [2] respectively.)

It is convenient to write x=z+tₗ for vectors x in the bin Bₗ. Since tₗ denotes the centre of the bin Bₗ, z is in B₀, the bin centred at the origin. The density estimates g₁ and g₂ may be rewritten in terms of vectors z, and the resulting functions denoted by g_{1,0} and g_{2,0} respectively.

g₁(x)=g₁(z+tₗ)=a₀+a^{T}(z+tₗ)=b₀+a^{T}z=g_{1,0}(z) (6)

where

b₀=a₀+a^{T}tₗ (7)

Likewise,

g₂(x)=a₀+a^{T}(z+tₗ)+(z+tₗ)^{T}Ax(z+tₗ)=b₀+b^{T}z+z^{T}Az=g_{2,0}(z) (8)

where

b=a+2Atₗ (9)

and

b₀=a₀+b^{T}tₗ+tₗ^{T}Atₗ (10)

Note that a in g₁ and A in g₂ are invariant under this transformation.

The coefficients b₀ and a of the FOPHE g_{1,0} are estimated in each bin B₁ using the following constraints:
The zero-th moment (number) nₗ of the observations Xᵢ in the bin Bₗ is preserved:

$${\int }_{{B}_{l}}^{ } {g}_{1} ( x ) d x = \frac{{n}_{l}}{n} \qquad ( 11 )$$

The first moment (mean) x̅ₗ of the observations Xᵢ in the bin Bₗ is preserved:

$${\int }_{{B}_{l}}^{ } x {g}_{1} ( x ) d x = \frac{{n}_{l}}{n} {\overline{x}}_{l} \qquad ( 12 )$$

Using the constraints in equations (11) and (12) and equation (6) in the bin Bₗ, the FOPHE coefficients b₀^{[1]} and a^{[1]} may be estimated from the zero-th and first moments as follows:

$$\begin{matrix}{\hat{b}}_{0}^{[ 1 ]} = \frac{1}{{h}^{d}} \frac{{n}_{l}}{n} & ( 13 ) \\ {\hat{a}}^{[ 1 ]} = \frac{12}{{h}^{d + 2}} \frac{{n}_{l}}{n} ( {\overline{x}}_{l} - {t}_{l} ) & ( 14 )\end{matrix}$$

An estimate â₀^{[1]} of the coefficient a₀^{[1]} of the original FOPHE g₁ (equation (4)) is derivable from the estimates \hat{b}₀^{[1]} and â^{[1]} using equation (7).

The coefficients b₀, b, and A of the SOPHE g_{2,0} are estimated under the constraints in equations (11) and (12), plus the constraint that the second moments of the observations Xᵢ in the bin Bₗ are preserved, i.e.

$${\int }_{{B}_{l}}^{ } x {x}^{T} {g}_{2} ( x ) d x = \frac{{n}_{l}}{n} {M}_{l} \qquad ( 15 )$$

Using the constraints in (11), (12), and (15), and the expression in (8) in the bin Bₗ, the SOPHE coefficients b₀, b, and A may be estimated from the zero-th and first moments and the “modified covariance” matrix S₁ as follows:

$$\begin{matrix}{\hat{b}}_{0}^{[ 2 ]} = \frac{1}{{h}^{d + 2}} \frac{{n}_{l}}{n} [ \frac{4 + 5 d}{4} {h}^{2} - 15 tr ( {S}_{l} ) ] & ( 16 ) \\ \hat{b} = \frac{12}{{h}^{d + 2}} \frac{{n}_{l}}{n} ( {x}_{l} - {t}_{l} ) \\ and & ( 17 ) \\ \hat{A} = \frac{1}{{h}^{d + 4}} \frac{{n}_{l}}{n} [ 72 {S}_{l} + 108 diag ( {S}_{l} ) - 15 {h}^{2} I ] & ( 18 )\end{matrix}$$

Estimates â₀^{[2]} and â^{[2]} of the coefficients a₀^{[2]} and a^{[2]} of the original SOPHE expression (equation (5)) are derivable from the estimates \hat{b}₀^{[2]}, \hat{b}, and Â using equations (9) and (10).

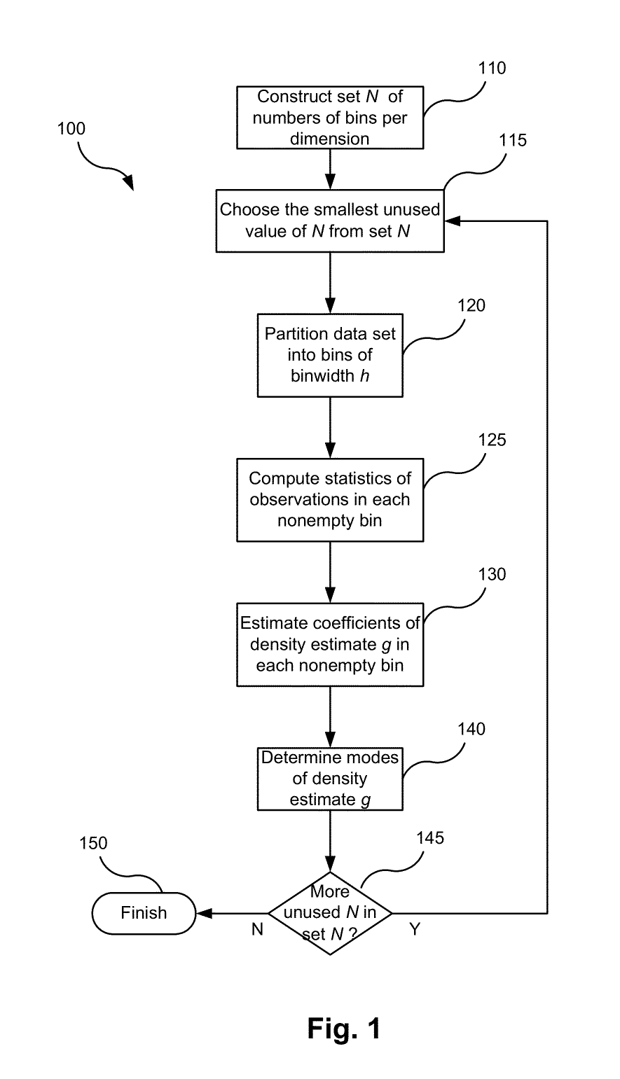

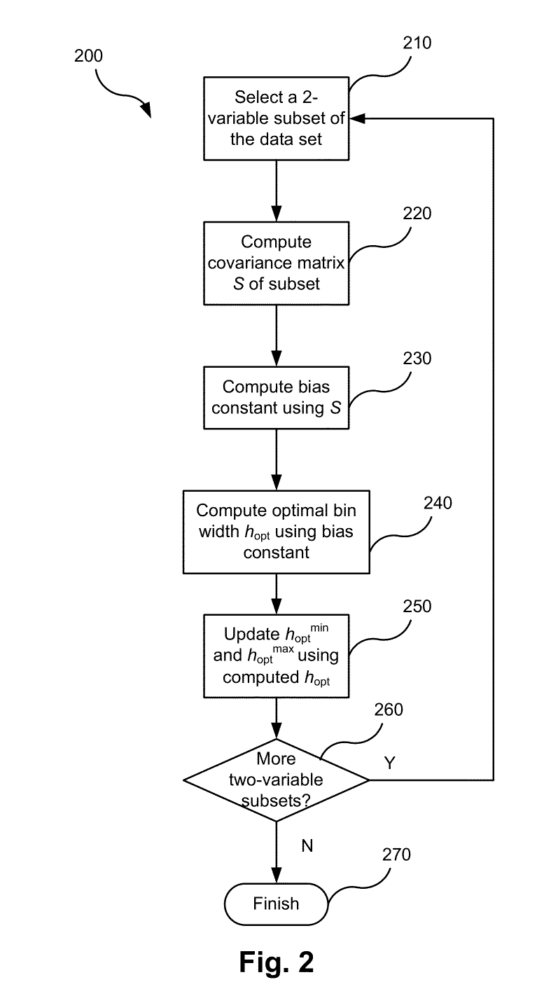

FIG. 1 is a flow chart illustrating a method 100 of cluster analysis of a multidimensional data set according to one embodiment. The method 100 uses a predetermined range [hₒₚₜ^{min}, hₒₚₜ^{max}] of “quasi-optimal” values for the binwidth. One method for determination of the range [hₒₚₜ^{min}, hₒₚₜ^{max}] is described below with reference to FIG. 2. The method 100 assumes the data set has been “standardised” (scaled and translated) to the range [0,R], where R>0, in each dimension. This allows the same binwidth to be used in all dimensions.

The method 100 starts at step 110, which constructs a set [symbol] of numbers of bins per dimension from the range [hₒₚₜ^{min}, hₒₚₜ^{max}] of “quasi-optimal” binwidths. In one implementation, the set [symbol] is constructed as

$$𝒩 = \{ [ \frac{R}{{h}_{opt}^{max}} ] , [ \frac{R}{{h}_{opt}^{max}} ] + 1 , … , [ \frac{R}{{h}_{opt}^{min}} ] \} \qquad ( 19 )$$

where [] indicates rounding to the nearest integer.

Step 115 follows, at which the smallest previously unused number N of bins per dimension is chosen from the set [symbol] . The total number of bins L is then N^{d}, and the binwidth h is R/N. Denote the total number of nonempty bins by M, where M is typically much smaller than the total number of bins L.

At the next step 120, the method 100 partitions the multidimensional data set into bins of uniform binwidth h. The bins are “cubic” in the sense that the same binwidth is used for all variables.

For a given value of N, the analysis steps 125 and 130 are carried out for each of the M nonempty bins, the nonempty bin index being l=0, . . . , M−1. At step 125, the method 100 computes the statistics of the observations X in the bin B₁. At step 130, the method 100 estimates the coefficients of the density estimate g in the bin B₁ based on the statistics computed in step 125. In one implementation of the method 100, the statistics computed at step 125 are the number nₗ and the mean x̅ₗ of the observations Xᵢ in the bin Bₗ, and the coefficients estimated at step 130 are those of the FOPHE g₁ (a₀^{[1]} and a^{[1]}), using equations (13), (14), and (7) above. In another implementation of the method 100, the statistics computed at step 125 are the number nₗ, the mean x̅ₗ, and the “modified covariance” matrix Sₗ of the observations Xᵢ in the bin Bₗ. The coefficients estimated at step 130 are those of the SOPHE g₂ (a₀^{[2]}, a^{[2]}, and A), using equations (16), (17), (18), (9) and (10) above.

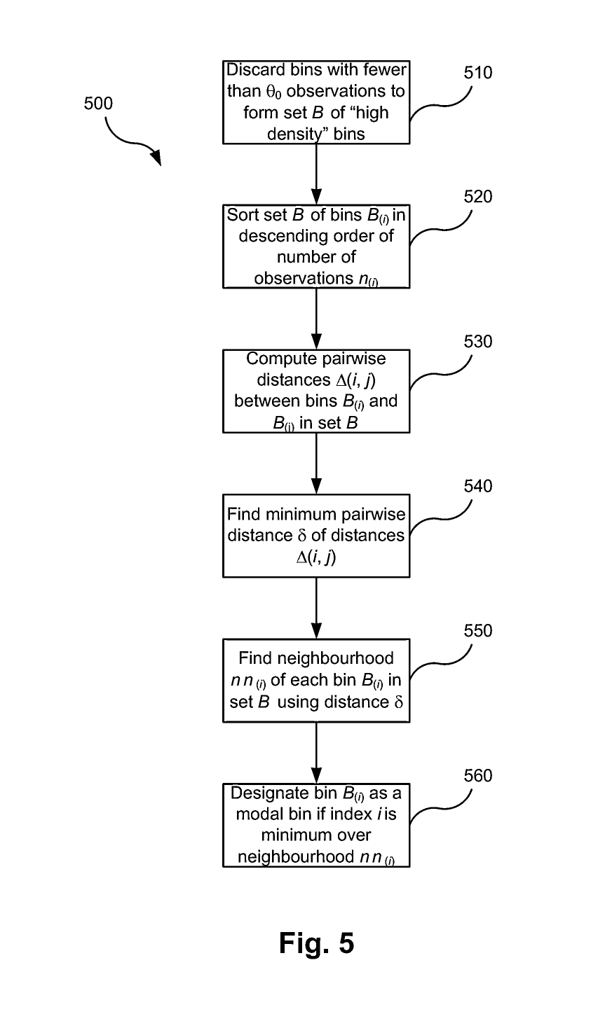

At the next step 140, after all the bins B₁ have been completed, the method 100 determines the modes (number and location) of the multidimensional data set using the current binwidth h. A method of determining the number and locations of the modes of a multidimensional data set as used in step 140 will be described in detail below with reference to FIG. 5. The method 100 then determines in step 145 whether there are any unused members N of the set [symbol] of numbers of bins per dimension. If so (“Y”), the method 100 returns to step 115. Otherwise (“N”), the method 100 concludes at step 150.

The number and location of the modes found by the step 140 may vary as N varies. The highest number of modes obtained over all iterations of step 140 is taken to be the final number of modes, and the corresponding value h of the binwidth is the “optimal” binwidth for the multidimensional data set.

In an alternative implementation, in step 145 the number of modes for a given N obtained in step 140 is compared with the number of modes obtained for the value of N in the previous iteration of step 140. If the number of modes has decreased since the previous iteration, the method 100 concludes at step 150. Otherwise, the method 100 returns to step 120. This implementation is effective because in practice, the number of modes increases as N increases, reaches a peak, and then decreases again. The number of modes at the previous iteration of step 140, i.e. the highest number of modes, is taken to be the final number of modes, and the corresponding value h of the binwidth is the “optimal” binwidth for the multidimensional data set.

Table 1 below shows a comparison of the asymptotic performance of FOPHE and SOPHE as the number n of observations tends to infinity with that of a histogram density estimator (effectively a zero-order polynomial histogram estimator, with a₀ set to nₗ/n) and a normal kernel density estimator. AISB is the asymptotic integrated squared bias over all bins, AIV is the asymptotic integrated variance over all bins, and AMISE is the asymptotic mean integrated squared error over all bins (which is the sum of the AISB and the AIV). C_{H,CK,} C_{F}, and C_{S} are “bias constants” that depend on the “true” density ƒ. The “optimal” binwidth is the binwidth that minimises the AMISE. The column in Table 1 headed “Optimal binwidth hₒₚₜ” shows the asymptotic behaviour of the “optimal” binwidth as the number n of observations tends to infinity. The entries in this column are obtained by equating the two terms in the corresponding AMISE sum, solving for h, and ignoring any constant multiplier that is independent of n.

It may be shown that as the number n of observations tends to infinity, the estimates it and â₀^{[1]} and â^{[1]} of the FOPHE coefficients and â₀^{[2]}, â^{[2]}, and Â of the SOPHE coefficients tend to the “correct” values. In other words, the AMISE at the optimal binwidth tends to zero, i.e. the estimates g₁ and g₂ tend to the “true” density ƒ.

The “convergence rate” column shows the asymptotic behaviour of the AMISE (evaluated at the optimal binwidth) as the number n of observations tends to infinity.

TABLE 1
Comparison of asymptotic performance of density estimators

| | | | | Opti- | |
|---|---|---|---|---|---|
| | | | | mal | Con- |
| Density | | | | bin- | ver- |
| esti- | | | | width | gence |
| mator: | AISB | AIV | AMISE | hₒₚₜ | rate |
| Histo- | C_{H}h² | 1/nh^{d} | C_{H}h² + 1/nh^{d} | n^{-1/(d+2)} | n^{-2/(d+2)} |
| gram | | | | | |
| kernel | C_{K}h⁴ | R(K)/nh^{d} | C_{K}h⁴ + R(K)/nh^{d} | n^{-1/(d+4)} | n^{-4/(d+4)} |
| FOPHE | C_{F}h⁴ | (d + 1)/nh^{d} | C_{F}h⁴ + (d + 1)/nh^{d} | n^{-1/(d+4)} | n^{-4/(d+4)} |
| SOPHE | C_{S}h⁶ | $\frac{( d + 1 ) ( d + 2 )}{2 {nh}^{d}}$ | ${C}_{S} {h}^{6} + \\ \frac{( d + 1 ) ( d + 2 )}{2 {nh}^{d}}$ | n^{-1/(d+6)} | n^{-6/(d+6)} |

In the third row of Table 1, R(K) is the constant for the variance of kernel density estimators.

Table 1 shows that asymptotically, the histogram estimator has the smallest optimal binwidth, and the slowest rate of convergence. FOPHE and the kernel estimator have the same convergence rates, while SOPHE has the largest optimal binwidth and the fastest rate of convergence.

In the example case where f is a Gaussian bivariate distribution (d=2) with a 2-by-2 covariance matrix E, the bias constants C_{H}, C_{K}, C_{F}, and C_{A} may be computed as follows:

$$\begin{matrix} {C}_{H} = \frac{1}{24} \frac{{\vert {Σ}^{- 1} \vert}^{\frac{1}{2}}}{4 π} tr ( {Σ}^{- 1} ) & ( 20 ) \\ {C}_{K} = \frac{1}{16} \frac{{\vert {Σ}^{- 1} \vert}^{\frac{1}{2}}}{4 π} \{ 2 tr ( {Σ}^{- 2} ) + {[ tr ( {Σ}^{- 1} ) ]}^{2} \} & ( 21 ) \\ {C}_{F} = \frac{1}{5760} \frac{{\vert {Σ}^{- 1} \vert}^{\frac{1}{2}}}{4 π} \{ \begin{matrix}10 tr ( {Σ}^{- 2} ) + {5 [ tr ( {Σ}^{- 1} ) ]}^{2} - \\ 9 tr ( {[ diag ( {Σ}^{- 1} ) ]}^{2} )\end{matrix} \} & ( 22 ) \\ {C}_{S} = \frac{1}{161280} \frac{{\vert {Σ}^{- 1} \vert}^{\frac{1}{2}}}{4 π} \{ tr ( {Σ}^{- 1} ) ( \begin{matrix}14 tr ( {Σ}^{- 2} ) + {2 [ tr ( {Ρ}^{- 1} ) ]}^{2} - \\ 13 tr ( {[ diag ( {Σ}^{- 1} ) ]}^{2} )\end{matrix} ) \} & ( 23 )\end{matrix}$$

where |Σ| denotes the determinant of Σ.

Using equations (20) to (23) in Table 1, together with the fact that R(K) for the normal product kernel estimator is (4π)^{-d/2}, it may be shown that the optimal binwidths of FOPHE and SOPHE in the bivariate Gaussian case are significantly larger than for the kernel and histogram estimators. In addition, FOPHE and SOPHE have a much larger range of binwidths over which near-optimal performance is achieved compared to the corresponding range for the kernel estimator. This property of FOPHE and SOPHE has computational advantages in that a larger binwidth means a smaller number of bins for estimation of the density. In addition, the wider range of near-optimal binwidths indicates that the polynomial histogram estimators are not as sensitive to the choice of binwidth as kernel estimators, thus enabling a more flexible choice of binwidth in clustering applications.

Where the number d of variables in a data set is greater than 2, a closed form solution for the optimal binwidth hₒₚₜ is difficult or impossible to derive. For the purposes of deriving a range [hₒₚₜ^{min},hₒₚₜ^{max}] of binwidths for use by the method 100 of FIG. 1, two-variable subsets of the multidimensional data set are selected. From each two-variable subset, a corresponding “quasi-optimal” binwidth hₒₚₜ is determined as described below with reference to FIG. 2. The minimum and maximum “quasi-optimal” values hₒₚₜ over all the selected two-variable subsets define the range [hₒₚₜ^{min},hₒₚₜ^{max}] of binwidths used by the method 100 as described above.

FIG. 2 is a flow chart illustrating a method 200 of determining a range [hₒₚₜ^{min},hₒₚₜ^{max}] of “quasi-optimal” binwidths for a multidimensional data set with three or more variables. The range [hₒₚₜ^{min},hₒₚₜ^{max}] returned by the method 200 may be used in the method 100 of FIG. 1. The method 200 starts at step 210 by selecting a two-variable subset of the multidimensional data set. At the next step 220, the method 200 computes the 2-by-2 sample covariance matrix S of the two-variable subset, which is an estimator for the true covariance matrix Σ of the two-variable subset. Step 230 follows, at which the method 200 computes the bias constant C_{F} (for FOPHE) or C_{S} (for SOPHE) using equation (22) or (23), with Σ replaced by the sample covariance matrix S. The method 200 continues at step 240 by determining the “quasi-optimal” value hₒₚₜ of the binwidth h for the two-variable data set using the bias constant C_{F} or C_{S} computed at step 230. Step 240 determines the “quasi-optimal” value hₒₚₜ of the binwidth h by equating the two terms in the AMISE sum as shown in Table 1 above, using the computed bias constant C_{F} or C_{S}, and solving for h. At the following step 250, the values hₒₚₜ^{min} and hₒₚₜ^{max} are updated using the “quasi-optimal” binwidth hₒₚₜ determined in step 240. In the first iteration, hₒₚₜ^{min} and hₒₚₜ^{max}are set to hₒₚₜ. In subsequent iterations, hₒₚₜ^{min} is set to hₒₚₜ if hₒₚₛ^{min}, and hₒₚₜ^{max} is set to hₒₚₜ if hₒₚₜ>hₒₚₜ^{max}. The method 200 then determines at step 260 whether there are any more two-variable subsets of the multidimensional data set. If so (“Y”), the method 200 returns to step 210. Otherwise (“N”), the method 200 concludes at step 270.

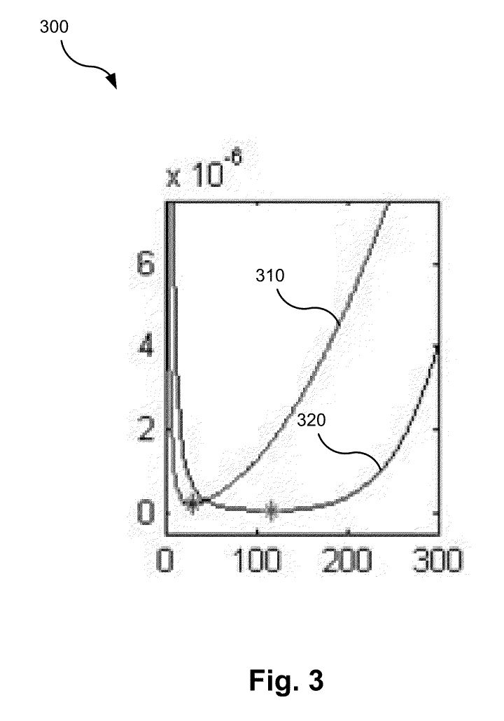

FIG. 3 contains a plot 300 of two “performance curves” (AMISE vs binwidth h) for a sample two-variable data set containing 10,000 observations: one (310) for the histogram estimator, and one (320) for the SOPHE. The optimal binwidth on each performance curve is marked with a star. The performance curves 310 and 320 show that the optimal SOPHE binwidth is about 4 times larger than that for histogram method, so a smaller number of bins is required to obtain a comparably accurate estimate of the density. In addition, the performance curve 310 has a larger minimum than the performance curve 320, showing that the histogram estimate is less accurate than the SOPHE. Furthermore, the performance curves 310 and 320 show that the SOPHE has a wider range of binwidths for which the performance is “near optimal”, so the performance of the SOPHE is not as sensitive to the exact choice of binwidth. This enables a more flexible choice of binwidth in practical applications.

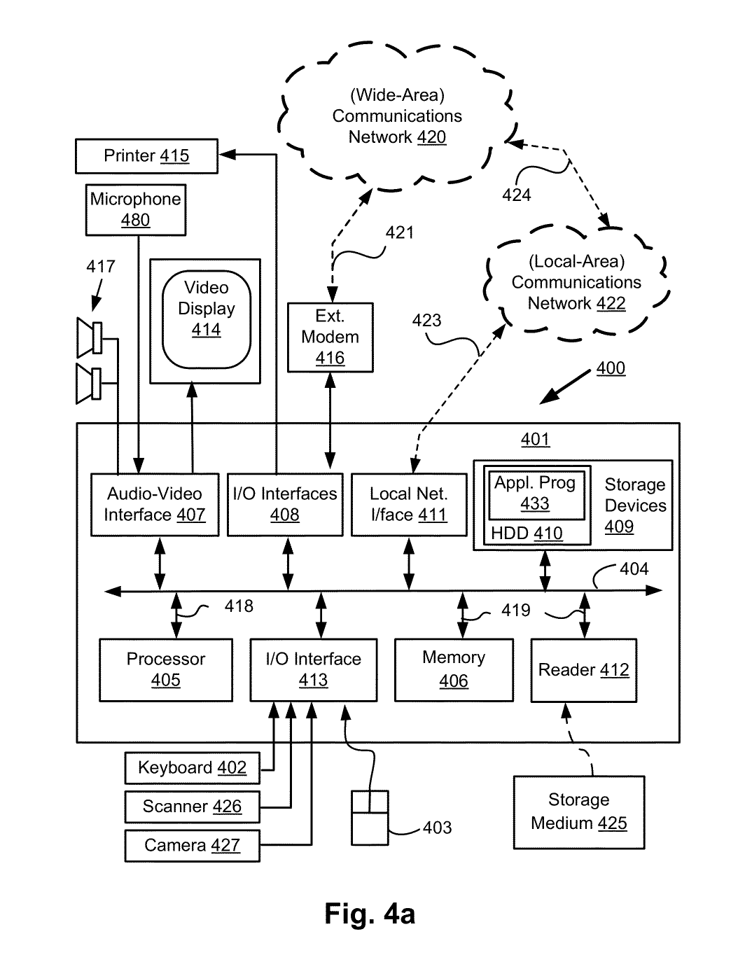

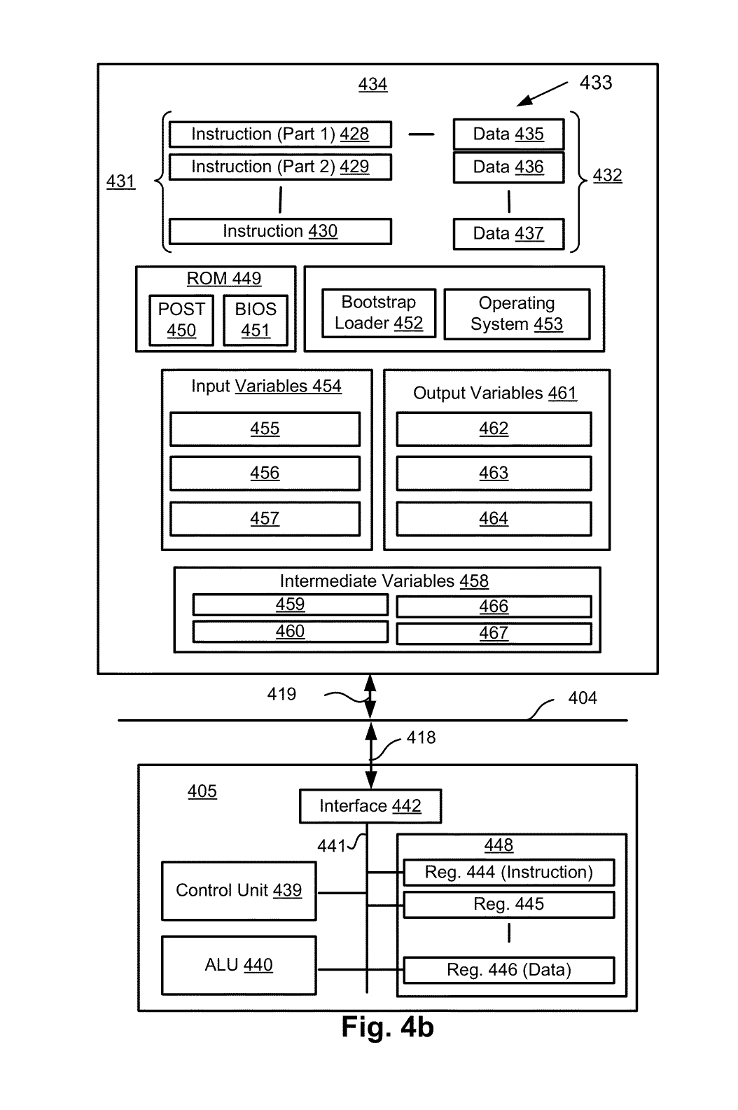

FIGS. 4A and 4B collectively form a schematic block diagram of a general purpose computer system 400, upon which the methods of FIGS. 1, 2, 5, and 6 may be practised.

As seen in FIG. 4A, the computer system 400 is formed by a computer module 401, input devices such as a keyboard 402, a mouse pointer device 403, a scanner 426, a camera 427, and a microphone 480, and output devices including a printer 415, a display device 414 and loudspeakers 417. An external Modulator-Demodulator (Modem) transceiver device 416 may be used by the computer module 401 for communicating to and from a communications network 420 via a connection 421. The network 420 may be a wide-area network (WAN), such as the Internet or a private WAN. Where the connection 421 is a telephone line, the modem 416 may be a traditional “dial-up” modem. Alternatively, where the connection 421 is a high capacity (eg: cable) connection, the modem 416 may be a broadband modem. A wireless modem may also be used for wireless connection to the network 420.

The computer module 401 typically includes at least one processor unit 405, and a memory unit 406 for example formed from semiconductor random access memory (RAM) and semiconductor read only memory (ROM). The module 401 also includes an number of input/output (I/O) interfaces including an audio-video interface 407 that couples to the video display 414, loudspeakers 417 and microphone 480, an I/O interface 413 for the keyboard 402, mouse 403, scanner 426, camera 427 and optionally a joystick (not illustrated), and an interface 408 for the external modem 416 and printer 415. In some implementations, the modem 416 may be incorporated within the computer module 401, for example within the interface 408. The computer module 401 also has a local network interface 411 which, via a connection 423, permits coupling of the computer system 400 to a local computer network 422, known as a Local Area Network (LAN). As also illustrated, the local network 422 may also couple to the wide network 420 via a connection 424, which would typically include a so-called “firewall” device or device of similar functionality. The interface 411 may be formed by an Ethernet™ circuit card, a Bluetooth™ wireless arrangement or an IEEE 802.11 wireless arrangement.

The interfaces 408 and 413 may afford either or both of serial and parallel connectivity, the former typically being implemented according to the Universal Serial Bus (USB) standards and having corresponding USB connectors (not illustrated). Storage devices 409 are provided and typically include a hard disk drive (HDD) 410. Other storage devices such as a floppy disk drive and a magnetic tape drive (not illustrated) may also be used. A reader 412 is typically provided to interface with an external non-volatile source of data. A portable computer readable storage device 425, such as optical disks (e.g. CD-ROM, DVD), USB-RAM, and floppy disks for example may then be used as appropriate sources of data to the system 400.

The components 405 to 413 of the computer module 401 typically communicate via an interconnected bus 404 and in a manner which results in a conventional mode of operation of the computer system 400 known to those in the relevant art. Examples of computers on which the described arrangements can be practised include IBM-PC's and compatibles, Sun Sparcstations, Apple Mac™ or computer systems evolved therefrom.

The methods of FIGS. 1, 2, 5, and 6 may be implemented using the computer system 400 as one or more software application programs 433 executable within the computer system 400. In particular, with reference to FIG. 4B, the steps of the described methods are effected by instructions 431 in the software 433 that are carried out within the computer system 400. The software instructions 431 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 433 is generally loaded into the computer system 400 from a computer readable medium, and is then typically stored in the HDD 410, as illustrated in FIG. 4A, or the memory 406, after which the software 433 can be executed by the computer system 400. In some instances, the application programs 433 may be supplied to the user encoded on one or more storage media 425 and read via the corresponding reader 412 prior to storage in the memory 410 or 406. Computer readable storage media refers to any non-transitory tangible storage medium that participates in providing instructions and/or data to the computer system 400 for execution and/or processing. Examples of such storage media include floppy disks, magnetic tape, CD-ROM, DVD, a hard disk drive, a ROM or integrated circuit, USB memory, a magneto-optical disk, semiconductor memory, or a computer readable card such as a PCMCIA card and the like, whether or not such devices are internal or external to the computer module 401. A computer readable storage medium having such software or computer program recorded on it is a computer program product. The use of such a computer program product in the computer module 401 effects an apparatus for cluster analysis of a multidimensional data set.

Alternatively the software 433 may be read by the computer system 400 from the networks 420 or 422 or loaded into the computer system 400 from other computer readable media. Examples of transitory or non-tangible computer readable transmission media that may also participate in the provision of software, application programs, instructions and/or data to the computer module 401 include radio or infra-red transmission channels as well as a network connection to another computer or networked device, and the Internet or Intranets including e-mail transmissions and information recorded on Websites and the like.

The second part of the application programs 433 and the corresponding code modules mentioned above may be executed to implement one or more graphical user interfaces (GUIs) to be rendered or otherwise represented upon the display 414. Through manipulation of typically the keyboard 402 and the mouse 403, a user of the computer system 400 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 417 and user voice commands input via the microphone 480.

FIG. 4B is a detailed schematic block diagram of the processor 405 and a “memory” 434. The memory 434 represents a logical aggregation of all the memory devices (including the HDD 410 and semiconductor memory 406) that can be accessed by the computer module 401 in FIG. 4A.

When the computer module 401 is initially powered up, a power-on self-test (POST) program 450 executes. The POST program 450 is typically stored in a ROM 449 of the semiconductor memory 406. A program permanently stored in a hardware device such as the ROM 449 is sometimes referred to as firmware. The POST program 450 examines hardware within the computer module 401 to ensure proper functioning, and typically checks the processor 405, the memory (409, 406), and a basic input-output systems software (BIOS) module 451, also typically stored in the ROM 449, for correct operation. Once the POST program 450 has run successfully, the BIOS 451 activates the hard disk drive 410. Activation of the hard disk drive 410 causes a bootstrap loader program 452 that is resident on the hard disk drive 410 to execute via the processor 405. This loads an operating system 453 into the RAM memory 406 upon which the operating system 453 commences operation. The operating system 453 is a system level application, executable by the processor 405, to fulfil various high level functions, including processor management, memory management, device management, storage management, software application interface, and generic user interface.

The operating system 453 manages the memory (409, 406) in order to ensure that each process or application running on the computer module 401 has sufficient memory in which to execute without colliding with memory allocated to another process. Furthermore, the different types of memory available in the system 400 must be used properly so that each process can run effectively. Accordingly, the aggregated memory 434 is not intended to illustrate how particular segments of memory are allocated (unless otherwise stated), but rather to provide a general view of the memory accessible by the computer system 400 and how such is used.

The processor 405 includes a number of functional modules including a control unit 439, an arithmetic logic unit (ALU) 440, and a local or internal memory 448, sometimes called a cache memory. The cache memory 448 typically includes a number of storage registers 444-446 in a register section. One or more internal buses 441 functionally interconnect these functional modules. The processor 405 typically also has one or more interfaces 442 for communicating with external devices via the system bus 404, using a connection 418.

The application program 433 includes a sequence of instructions 431 that may include conditional branch and loop instructions. The program 433 may also include data 432 which is used in execution of the program 433. The instructions 431 and the data 432 are stored in memory locations 428-430 and 435-437 respectively. Depending upon the relative size of the instructions 431 and the memory locations 428-430, a particular instruction may be stored in a single memory location as depicted by the instruction shown in the memory location 430. Alternately, an instruction may be segmented into a number of parts each of which is stored in a separate memory location, as depicted by the instruction segments shown in the memory locations 428-429.

In general, the processor 405 is given a set of instructions which are executed therein. The processor 405 then waits for a subsequent input, to which it reacts to by executing another set of instructions. Each input may be provided from one or more of a number of sources, including data generated by one or more of the input devices 402, 403, data received from an external source across one of the networks 420, 422, data retrieved from one of the storage devices 406, 409 or data retrieved from a storage medium 425 inserted into the corresponding reader 412. The execution of a set of the instructions may in some cases result in output of data. Execution may also involve storing data or variables to the memory 434.

The methods of FIGS. 1, 2, 5, and 6 use input variables 454, that are stored in the memory 434 in corresponding memory locations 455-458. The methods of FIGS. 1, 2, 5, and 6 produce output variables 461, that are stored in the memory 434 in corresponding memory locations 462-465. Intermediate variables may be stored in memory locations 459, 460, 466 and 467.

The register section 444-446, the arithmetic logic unit (ALU) 440, and the control unit 439 of the processor 405 work together to perform sequences of micro-operations needed to perform “fetch, decode, and execute” cycles for every instruction in the instruction set making up the program 433. Each fetch, decode, and execute cycle comprises:
(a) a fetch operation, which fetches or reads an instruction 431 from a memory location 428;
(b) a decode operation in which the control unit 439 determines which instruction has been fetched; and
(c) an execute operation in which the control unit 439 and/or the ALU 440 execute the instruction.

Thereafter, a further fetch, decode, and execute cycle for the next instruction may be executed. Similarly, a store cycle may be performed by which the control unit 439 stores or writes a value to a memory location 432.

Each step or sub-process in the processes of FIGS. 1, 2, 5, and 6 is associated with one or more segments of the program 433, and is performed by the register section 444-447, the ALU 440, and the control unit 439 in the processor 405 working together to perform the fetch, decode, and execute cycles for every instruction in the instruction set for the noted segments of the program 433.

The methods of FIGS. 1, 2, 5, and 6 may alternatively be implemented in dedicated hardware such as one or more integrated circuits performing the functions or sub functions of the methods. Such dedicated hardware may include graphic processors, digital signal processors, or one or more microprocessors and associated memories.

FIG. 5 is a flow chart illustrating a method 500 of determining the number and locations of the modes of a multidimensional data set.

The method 500 may be used in step 140 of the method 100 of FIG. 1. In the method 100, the “optimal” binwidth is determined jointly with the number of modes by repeated iterations of the step 140 with different “quasi-optimal” values of binwidth. As described above, the method 100 selects as “optimal” the binwidth that yields the largest number of modes.

Alternatively, the method 500 may be used on any d-dimensional data set that has been partitioned into bins. The correctness of the number and locations of modes returned by the method 500 is dependent on how close the binwidth of the partition is to the “optimal” binwidth.

The method 500 requires a predetermined “density threshold” θ₀.

The method 500 starts at step 510, where the method 500 discards bins B₁ with fewer than θ₀ observations. The remaining “high density” bins form a set [symbol] . The bins in the “high density” set [symbol] are indexed by a subscript (i), so that each B₍ᵢ₎ in [symbol] has n₍ᵢ₎≧θ₀ observations.

At the next step 520, the method 500 sorts the bins B₍ᵢ₎ in the “high density” set [symbol] in descending order of number of observations n₍ᵢ₎, so that n₍₁₎>n₍₂₎. . .>. . .

Step 530 follows, at which the method 500 computes pairwise Euclidean distances Δ(i, j) between the centres t_{(i), t}₍ⱼ₎ of all pairs of bins B₍ᵢ₎, B₍ⱼ₎ in the high density set [symbol] . (Note Δ(i, i)==θ). In step 540, the minimum δ of all the distances Δ(i, j) between centres of bins in the high density set [symbol] is found. The minimum distance δ may increase with the dimensionality of the data, however the default is h, the binwidth.

The method 500 then proceeds to step 550, at which a neighbourhood nn₍ᵢ₎ of “neighbouring” bins is found for each bin B₍ᵢ₎ in the high density set [symbol] , starting with the bin B(₁) that has the highest density. The neighbourhood [symbol] ₍ᵢ₎ of the bin B₍ᵢ₎ indexed by i within [symbol] is defined as a set of indices j of bins B₍ⱼ₎ within [symbol] whose distance Δ(i, j) from the bin B₍ᵢ₎ is less than or equal to 1.8 times the minimum distance δ:

[symbol]

₍ᵢ₎={j:Δ(i,j)≦1.8δ} (24)

At the last step 560 of the method 500, a bin B(i) is designated as a “modal bin” if the bin index i is the minimum over the neighbourhood [symbol] ₍ᵢ₎, that is, the bin B₍ᵢ₎ contains the largest number of observations within the neighbourhood [symbol] ₍ᵢ₎. The location of the mode is taken to be the centre of the modal bin. Alternatively, if a more precise value for the location of the mode is desired, or if two bins in the same neighbourhood have the same number of observations (a tie), the steps 125 and 130 described above will be carried out using SOPHE to form an estimate g₂ of the density within the, or each, modal bin. In this case the bin centre will be replaced by the coordinates that have the largest g₂ value; and the bin with the larger g₂ value will be the modal bin in case of a tie. The location of the mode is then the location of the maximum of g₂ within the modal bin. The location x₀ of the maximum of g₂ within the modal bin is given by

$${x}_{0} = - \frac{1}{2} {\hat{A}}^{- 1} {\hat{a}}^{[ 2 ]} \qquad ( 25 )$$

where â^{[2]} and Â are the SOPHE coefficient estimates within the modal bin.

If the method 500 is being carried out as step 140 of the method 100, the density estimate g₂ within the modal bin is already available from the preceding iteration of step 130.

Modal regions can be determined as the set of high density bins that are adjacent to each modal bin. Modal regions are related to excess sets and level sets, but are not the same, since in either of these, an absolute level is set and one finds globally which observations are at that level or above. The level sets are therefore a theoretical notion only. For the relatively large bins appropriate for the SOPHE, precise level sets are not meaningful in practice. Instead the regions around the modes that contain more than a certain predetermined number of observations may be found.

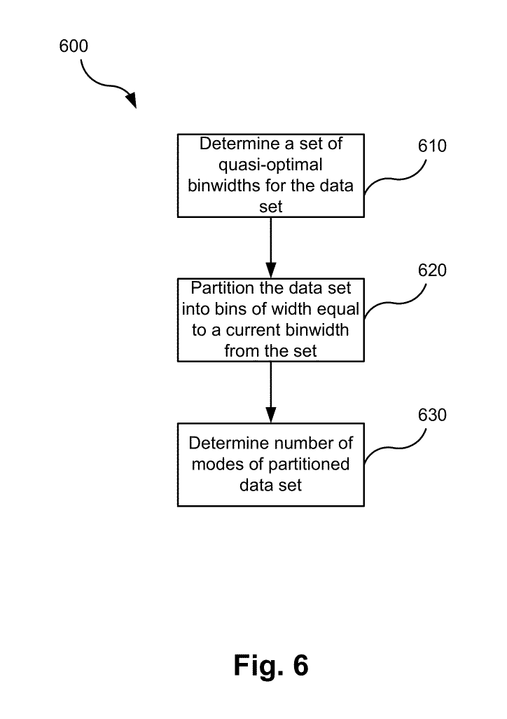

FIG. 6 is a flow chart illustrating a method 600 of cluster analysis of a multidimensional data set. The method 600 starts at step 610, which determines a set of quasi-optimal binwidths for the multidimensional data set. At the next step 620, the method 600 partitions, for a current binwidth in the set of quasi-optimal binwidths, the multidimensional data set into a plurality of bins of width equal to the current binwidth. Step 630 follows, at which the number of modes of the partitioned data set is determined for the current binwidth. Steps 620 and 630 are repeated for each binwidth in the set of quasi-optimal binwidths. The number of clusters is the largest number of modes determined at step 630 over the set of quasi-optimal binwidths.

The arrangements described are applicable to the medical research industries.

The foregoing describes only some embodiments of the present invention, and modifications and/or changes can be made thereto without departing from the scope and spirit of the invention, the embodiments being illustrative and not restrictive.

1. A method of cluster analysis of a data set of multidimensional observations, the method comprising:
determining a set of quasi-optimal binwidths for the data set;
partitioning, for a current binwidth in the set of quasi-optimal binwidths, the data set into a plurality of bins of width equal to the current binwidth;
determining the number of modes of the partitioned data set for the current binwidth; and
repeating the partitioning and determining the number of modes for each binwidth in the set of quasi-optimal binwidths,
wherein the number of clusters in the data set is the largest determined number of modes over the set of quasi-optimal binwidths.

2. A method according to claim 1, wherein the data set is obtained from flow cytometry.

3. A method according to claim 2, wherein the data set is obtained from a patient, the method further comprising diagnosing a disease in the patient by comparing at least one of the number, location, and extent of the clusters of the data set with the number, location, and extent of the clusters of a different data set obtained by flow cytometry from a healthy subject.

4. A method according to claim 2, wherein the data set is obtained from a patient, the method further comprising monitoring the progress of a disease in the patient by comparing at least one of the number, location, and extent of the clusters of the data set with the number, location, and extent of the clusters of a different data set obtained by flow cytometry from the patient at a different time.

5. A method according to claim 1, wherein the determining the number of modes comprises:
discarding bins containing fewer than a threshold number of observations to form a set of high-density bins;
finding a neighbourhood of each high-density bin in the set; and
designating a high-density bin as a modal bin if the high-density bin contains the largest number of observations within the neighbourhood of the high-density bin,
wherein each mode corresponds to a modal bin.

6. A method according to claim 5, wherein the finding the neighbourhood comprises:
computing pairwise distances between the centres of all pairs of high-density bins;
determining the minimum of the computed pairwise distances; and
finding, for each high-density bin, the set of high-density bins whose pairwise distance from the high-density bins is less than or equal to a constant times the determined minimum distance.

7. A method according to claim 5, further comprising, for each modal bin:
computing statistics of the observations in the modal bin;
estimating the density of the observations in the modal bin using the computed statistics; and
finding the maximum of the density estimate in the modal bin,
wherein the location of the mode is the location of the maximum of the density estimate in the corresponding modal bin.

8. A method according to claim 7, wherein the estimating the density comprises forming a second-order polynomial histogram estimate of the density.

9. A method according to claim 1, further comprising, for each bin:
computing statistics of the observations in the bin; and
estimating the density of the observations in the bin using the computed statistics.

10. A method according to claim 9, wherein the estimating the density comprises forming a second-order polynomial histogram estimate of the density.

11. A method according to claim 1, wherein the determining a set of quasi-optimal binwidths for the data set comprises:
selecting a two-variable subset of the data set;
finding a quasi-optimal binwidth for the two-variable subset;
updating the endpoints of the set of quasi-optimal binwidths using the determined quasi-optimal binwidth; and
repeating the selecting, finding, and updating for at least one other two-variable subset of the data set.

12. A method according to claim 11, wherein finding a quasi-optimal binwidth for the two-variable subset comprises finding the value of binwidth that minimises, over all bins, the asymptotic mean integrated squared error of an estimate of the density of the two-variable subset.

13. A method according to claim 12, wherein the estimate of the density is a second-order polynomial histogram estimate.

14. A computer readable medium on which is recorded computer program code executable by a computer apparatus to cause the computer apparatus to perform a method of cluster analysis of a data set of multidimensional observations, said code comprising:
code for determining a set of quasi-optimal binwidths for the data set;
code for partitioning, for a current binwidth in the set of quasi-optimal binwidths, the data set into a plurality of bins of width equal to the current binwidth;
code for determining the number of modes of the partitioned data set for the current binwidth; and
code for repeating the partitioning and determining the number of modes for each binwidth in the set of quasi-optimal binwidths,
wherein the number of clusters in the data set is the largest determined number of modes over the set of quasi-optimal binwidths.

15. Computer program code executable by a computer apparatus to cause the computer apparatus to perform a method of cluster analysis of a data set of multidimensional observations, said code comprising:
code for determining a set of quasi-optimal binwidths for the data set;
code for partitioning, for a current binwidth in the set of quasi-optimal binwidths, the data set into a plurality of bins of width equal to the current binwidth;
code for determining the number of modes of the partitioned data set for the current binwidth; and
code for repeating the partitioning and determining the number of modes for each binwidth in the set of quasi-optimal binwidths,
wherein the number of clusters in the data set is the largest determined number of modes over the set of quasi-optimal binwidths.
